(19) United States
(12) Patent Application Publication
(10) Pub. No.: US 2023/0313748 A1
(43) Pub. Date: Oct. 5, 2023

(54) METHODS AND SYSTEMS OF CONTROLLING A VEHICLE TO SUPPORT ELECTRICAL LOADS EXTERNAL TO THE VEHICLE

(71) Applicant: Ford Global Technologies, LLC, Dearborn, MI (US)

(72) Inventors: Stuart C. Salter, White Lake, MI (US); Deborah Bjorge, Northville, MI (US); Ryan J. O'Gorman, Beverly Hills, MI (US); Vyas Shenoy, Canton, MI (US); Peter Phung, Windsor (CA); Mark J. Ferrel, Brighton, MI (US)

(21) Appl. No.: 17/713,661

(22) Filed: Apr. 5, 2022

(51) Int. Cl. F02D 29/06; B60W 10/06; B60L 55/00

(52) U.S. Cl. CPC F02D 29/06; B60W 10/06; B60L 55/00; F02D 2200/025

(57) ABSTRACT

A method, includes operating a vehicle to generate electrical power, outputting the electrical power from the vehicle to one or more loads external to the vehicle, and adjusting the operating based, at least in part, on noise generated by the vehicle during the operating. The operating can include operating an engine of the vehicle.

### TECHNICAL FIELD

This disclosure relates generally to controlling a vehicle that can power an external load.

### BACKGROUND

Some vehicles can power loads external to the vehicle. The vehicles can essentially operate as a generator that can provide exportable power to electrical tools, appliance, device, and systems.

### SUMMARY

In some aspects, the techniques described herein relate to a method, including: operating a vehicle to generate electrical power; outputting the electrical power from the vehicle to one or more loads external to the vehicle; and adjusting the operating based, at least in part, on noise generated by the vehicle during the operating.

In some aspects, the techniques described herein relate to a method, wherein the operating includes operating an engine of the vehicle.

In some aspects, the techniques described herein relate to a method, wherein adjusting the operating includes adjusting an idle speed of the engine.

In some aspects, the techniques described herein relate to a method, further including monitoring the noise generated by the vehicle using at least one sensor of the vehicle.

In some aspects, the techniques described herein relate to a method, wherein the at least one sensor is a microphone.

In some aspects, the techniques described herein relate to a method, wherein the adjusting includes adjusting based on a time of day.

In some aspects, the techniques described herein relate to a method, wherein the adjusting is in response to noise generated by the vehicle exceeding a threshold noise level, wherein the threshold noise level changes based on a time of day.

In some aspects, the techniques described herein relate to a method, wherein the threshold noise level is higher during the day than at night.

In some aspects, the techniques described herein relate to a method, further including additionally adjusting the operating based, at least in part, on a weather condition.

In some aspects, the techniques described herein relate to a method, wherein the weather condition is a temperature.

In some aspects, the techniques described herein relate to a method, further including additionally adjusting the operating based, at least in part, on a temperature of an area of the vehicle.

In some aspects, the techniques described herein relate to a method, wherein the operating is responsive to a request by a user of a vehicle to power the one or more loads external to the vehicle.

In some aspects, the techniques described herein relate to a method, wherein the one or more loads includes a load from a residential home.

In some aspects, the techniques described herein relate to a method, wherein the load from the residential home is adjusted based on the electrical power outputted from the vehicle.

In some aspects, the techniques described herein relate to a method, further including additionally adjusting the operating based, at least in part, on a temperature within an engine compartment of the vehicle.

In some aspects, the techniques described herein relate to a method, further including, during the outputting, including an outputting of power from a 12-Volt system of the vehicle.

In some aspects, the techniques described herein relate to a method, further including, automatically starting the operating in response to a power outage.

In some aspects, the techniques described herein relate to a system for a vehicle, including: an engine that can be driven to produce electrical power that is supplied to one or more loads that are external to the vehicle; and a controller module that can adjusting an operating speed of the engine based, at least in part, on noise generated by the vehicle.

In some aspects, the techniques described herein relate to a system, wherein the controller module is configured to automatically start the engine in response to a power outage.

In some aspects, the techniques described herein relate to a system, wherein the adjusting is in response to noise generated by the vehicle exceeding a threshold noise level, wherein the threshold noise level changes based on a time of day.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a vehicle supplying electrical energy to a load.

FIG. 2 illustrates a highly schematic view of the vehicle of FIG. 1.

FIG. 3 illustrates a close-up view of an outlet of the vehicle of FIG. 1.

FIG. 4 illustrates a flow of a method associated with powering the load of FIG. 1 from the vehicle of the FIG. 1.

### DETAILED DESCRIPTION

This disclosure relates to methods of operating a vehicle to power a load that is external to the vehicle, such as operating a vehicle to supporting household loads during power outage conditions. The vehicle can generate noise when operating. In some implementations, when operating the vehicle to power the load, the operating of the vehicle is adjusted so that the vehicle does not exceed a threshold amount of noise. These and other features of this disclosure are discussed in greater detail in the following paragraphs of this detailed description.

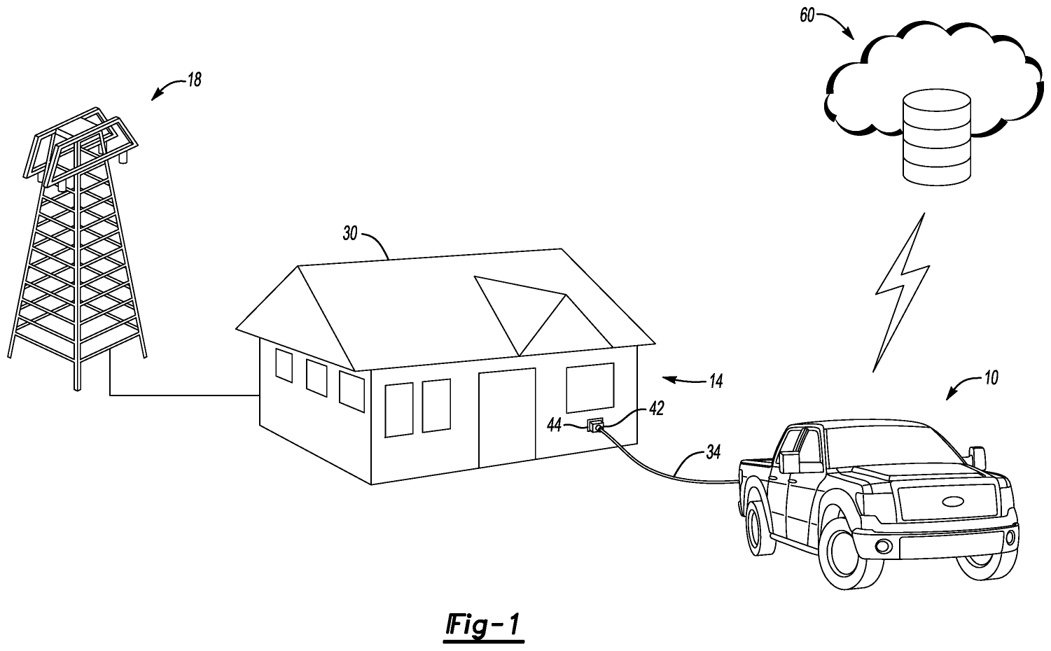

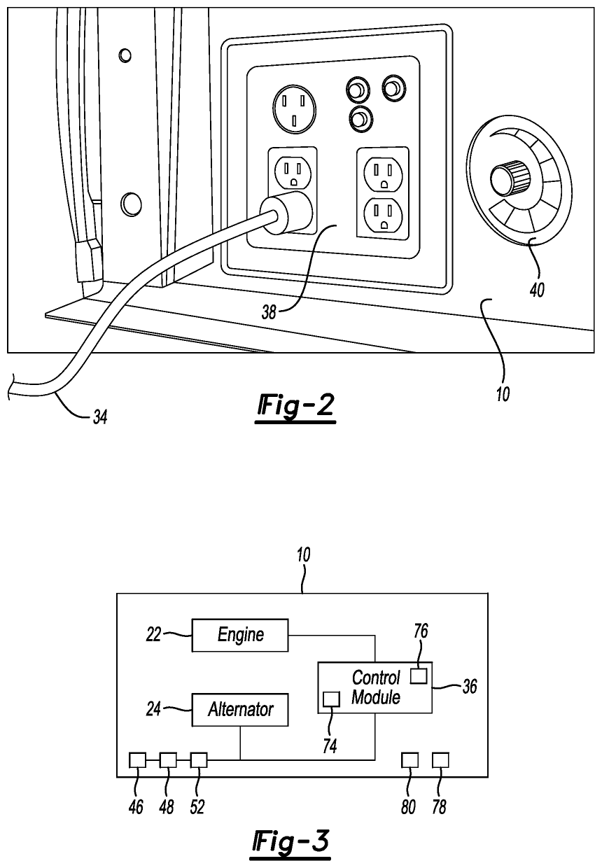

With reference to FIGS. 1-3, a vehicle 10 can supply electrical energy to a load 14 that is external to the vehicle 10. In this example, a grid power source 18 is unable to supply electrical energy to the load 14 due to a grid power outage.

The vehicle 10 includes an internal combustion engine 22, an alternator 24, and a control module 36. The control module 36 of the vehicle 10 can control operation of the engine 22, including controlling an operating speed of the engine 22 to adjust an amount of power generated by the engine 22. That is, the control module 36 can actively adjust an idle speed of the engine 22 to produce a desired output power level.

The alternator 24 can be a 48 Volt alternator. Operating the example engine 22 can generate up to 10 Kilowatts of power through the alternator 24.

The example vehicle 10 is a conventional vehicle. In another example, the vehicle 10 is a plug-in type electric vehicle (e.g., a plug-in hybrid electric vehicle (PHEV)).

The vehicle 10 is schematically illustrated as a pickup truck. However, other vehicle configurations are also contemplated. The teachings of this disclosure may be applicable for any type of vehicle as the vehicle 10. For example, the vehicle 10 could be configured as a car, a truck, a van, a sport utility vehicle (SUV), etc.

The load 14 can be a load of a structure 30, which can be a residential building, a commercial building, a parking garage, a charging station, or any other type of structure that is capable of receiving or transferring energy. In the exemplary embodiment, the structure 30 is a residential household that functions as a “home location” of the vehicle 10. The load 14 can include a load associated with common kitchen appliances, washers, dryers, water heaters, air conditioning units, furnaces, home alarms systems, sump pump systems, routers, etc.

The load 14 could be other energy units in other examples, such as an electrified vehicle, a stationary energy storage system, or a power pack. The load 14 could be associated with charging a home storage battery so that the vehicle 10 would not need to be relied on for power at certain times. The home storage battery could power a home during evenings (so the vehicle 10 could be turned off), while refueling the vehicle 10, or while using the vehicle 10 for transportation.

Although a specific component relationship is illustrated in the figures of this disclosure, the illustrations are not intended to limit this disclosure. The placement and orientation of the various components of the depicted system are shown schematically and could vary within the scope of this disclosure. In addition, the various figures accompanying this disclosure are not necessarily drawn to scale, and some features may be exaggerated or minimized to emphasize certain details of a particular component.

The vehicle 10 is electrically coupled to the load 14 through an electrical harness 34. One end of the electrical harness 34 plugs into an electrical outlet 38 of the vehicle 10. Energy from the engine 22 and alternator 24 is sent to the electrical outlet 38. The vehicle 10, in some examples, can include an adjustor 40 such as a knob, dial, or DIP switch near the electrical outlet 38. The user can manipulate the adjustor to change the flow of electrical power from the vehicle 10.

An opposite end of the electrical harness 34 plugs into an electrical outlet 42 of the structure 30. Electrical power generated by the vehicle 10 can then, for example, backfeed an electrical panel of the structure 30. When the vehicle 10 is used to power the structure 30, an automatic transfer switch of the structure 30 can be automatically transitioned to isolate the structure 30 from the grid power source 18.

The engine 22 can be strategically controlled to support the essential loads of the structure 30. For example, when power outage conditions occur such that energy from the grid power source 18 is temporarily unavailable, the control module 36 can automatically start the engine 22 to power the structure 30. That is, the engine 22 is automatically started in response to the power outage. In such an example, the user has, prior to the outage, plugged in the electrical harness 34 to ensure that the automatic start will be able to deliver power to the structure 30.

In some examples, a smart load panel 44 of the structure 30 can actively adjust the various loads of the structure to ensure, for example, the operation of essential household appliances and other essential elements of the structure 30 functionality for the duration of the power outage condition. The smart load panel could actively adjust the various loads to match a maximum power output from the vehicle 10.

The vehicle 10 may include a telecommunications module 46, a global positioning system (GPS) 48, and a human machine interface (HMI) 52. These and other components may be interconnected and in electronic communication with one another over a communication bus of the vehicle 10. The communication bus may be a wired communication bus such as a controller area network (CAN) bus, or a wireless communication bus such as Wi-Fi, Bluetooth®, Ultra-Wide Band (UWB), etc.

The telecommunications module 46 may be configured to communicate with a cloud-based server system 60. The telecommunications module 46 may communicate over a cloud network (e.g., the internet) to obtain various information stored on the server system 60 or to provide information to the server system 60 that can subsequently be accessed by the vehicle 10 (and/or other participating vehicles or structures). The server system 60 can identify, collect, and store user data associated with the vehicle 10 for validation purposes. Upon an authorized request, data may be subsequently transmitted to the telecommunications module 46 via one or more cellular towers or some other known communication technique (e.g., Wi-Fi, Bluetooth®, data connectivity, etc.). The telecommunications module 46 can receive data from the server system 60 or can communicate data back to the server system 60 via the cellular tower(s). Although not necessarily shown or described in this highly schematic embodiment, numerous other components may enable bidirectional communications between the vehicle 10 and the server system 60.

In an embodiment, a user/owner of the vehicle 10 may interface with the server system 60 for coordinating energy transfer related events using the HMI 52. For example, the HMI 52 may be equipped with an application (e.g., FordPass™ or another similar web-based application) for interfacing with the server system 60. The HMI 52 may be located within a passenger cabin of the vehicle 10 and may include various user interfaces for displaying information to the vehicle occupants and for allowing the vehicle occupants to enter information into the HMI 52. The vehicle occupants may interact with the user interfaces presentable on the HMI 52 via touch screens, tactile buttons, audible speech, speech synthesis, etc.

In another embodiment, the user/owner of the vehicle 10 may alternatively or additionally interface with the server system 60 for coordinating energy transfer related events using a personal electronic device (e.g., a smart phone, tablet, computer, wearable smart device, etc.). The personal electronic device may include an application (e.g., FordPass™ or another similar application) that includes programming to allow the user to employ one or more user interfaces for setting or controlling certain aspects of the system. The application may be stored in a memory of the personal electronic device and may be executed by a processor of the personal electronic device.

The control module 36 may include both hardware and software and could be part of an overall vehicle control system, such as a vehicle system controller (VSC), or could alternatively be a stand-alone controller separate from the VSC. In an embodiment, the control module 36 is programmed with executable instructions for interfacing with and commanding operation of various components of the system.

Although shown as separate modules within the highly schematic depiction of FIG. 3, the telecommunications module 46, the GPS 48, the HMI 52, and the control module 36 could be integrated together as part of common module of the vehicle 10.

The control module 36 may include a processor 74 and non-transitory memory 76 for executing various control strategies and modes. The processor 74 can be a custom made or commercially available processor, a central processing unit (CPU), or generally any device for executing software instructions. The memory 76 can include any one or combination of volatile memory elements and/or nonvolatile memory elements.

The processor 74 may be operably coupled to the memory 76 and may be configured to execute one or more programs stored in the memory 76 of the control module 36 based on the various inputs received from other devices, such as the server system 60, the 14, the telecommunications module 46, the GPS 48, the HMI 52, the traction battery pack 16, etc. In an embodiment, the application 54 (e.g., FordPass™ or another similar application), which includes programming for allowing the vehicle user to employ one or more user interfaces within the HMI 52 for setting or controlling certain aspects of the system, may be stored in the memory 76 and may be executed by the processor 74 of the control module 36. Alternatively, the control module 36 may be configured to communicate and interface with the personal electronic device 58 for coordinating and/or executing certain aspects of the system.

The control module 36 may receive and process various inputs in preparation for rationing energy from the vehicle 10 for supporting select all or portions of the loads 14 of the structure 30 during power outage conditions of the grid power source 18. More particularly, the control module 36 may receive various inputs that may be utilized for preparing a rationed energy transfer strategy that is most appropriate for any given structure/vehicle/grid condition. The rationed transfer energy strategy may control how energy is ultimately transferred during the power outage condition.

A first input to the control module 36 may include information associated with the structure 30. The household information may include pre-programmed or machine learning energy profiles for various home appliances that are part of the loads 14, historical energy usage (e.g., energy logs) of the structure 30, smart meter readings (e.g., current consumption of total energy in readings through voltage, current, and power factor levels), smart appliance information (e.g., status of appliance use, notifications, energy profiles, energy use per unit of appliance usage, etc.), other appliance inputs (e.g., current sensor and temperature sensor information, etc.), customer preference information (e.g., customer energy transfer settings received from the applications, etc.), etc.

Another input to the control module 36 may include vehicle information received from various components/subsystems of the vehicle 10. The vehicle information may include information such as a temperature of the vehicle 10, such as an ambient temperature within an engine compartment of the vehicle 10. At least one sensor 78 of the vehicle 10 is used to detect the ambient temperature within the engine compartment.

Another input to the control module 36 could include noise level readings and, more particularly, Noise Vibration Harshness (NVH) readings. The NVH readings can be taken by at least one sensor 78 of the vehicle 10. The at least one sensor 78 of the vehicle 10 could include a microphone for example. The microphone can be used to monitor the noise generated by the vehicle 10.

The control module 36 can, based on the noise information, adjust a speed of the engine 22 to achieve a desired NVH from the vehicle 10. For example, when the noise information from the at least one sensor 78 indicate that noise from the vehicle 10 is exceeding a threshold noise level, the control module 36 may slow the speed of the engine 22 to reduce the noise from the vehicle 10.

The adjusting may be based in part on a time of day, which can be interpreted from an internal clock of the vehicle 10. For example, the threshold noise level that prompts the control module 36 to slow the speed can be higher during the day than at night. To reduce noise, the smart load panel 44 may turn off certain devices to reduce an overall power requirement from the vehicle 10. The engine 22 could then operate at a lower RPM, which decreases noise from the vehicle 10.

In particular, the control module 36 can adjust the electrical output from the vehicle 10 based on NVH and time of day. For example, during nighttime, there might be emphasis on NVH. The control module 36 could present the user with options for operating the engine 22 to generate power. An options could include increasing RPMs of the engine 22, which increases NVH but may be required to meet a particular demand. NVH might be noisy. Another option could include decreasing RPMs of the engine 22, which decreases NVH. A scaling factor with respect to noise levels could be presented to the user in the form of examples as opposed to dB values as an option.

In another example, the control module 36 can adjust electrical output from the vehicle 10 based on ambient temperature. During cold weather, there might be emphasis on efficiency and the control module 36 can cause a notification to be sent to the user with available options. Example options can include increasing RPMS of the engine 22 to overcome cold weather inefficiencies and meet output demands. Another option can include decrease RPMs of the engine 22 to scale back cold weather inefficiencies, which lowers output demands and conserves fuel. A scaling factor with respect to fuel levels would be presented on expected PPO output for customer to decide trade offs

In some examples, the control module 36 can collect inputs that include historical power usage for the load 14. The control module 36 can then operate the engine 22 while relying on predicted energy usage.

Another input to the control module 36 can include weather conditions from the server system 60. The weather conditions could include ambient temperatures around the vehicle 10, and predicted weather conditions around the vehicle 10. The control module 36 can adjust operation of the engine 22 based on the weather conditions or predicted weather conditions.

The control module 36 can, in some examples, provide the user of the vehicle 10 options for different amounts of power generation. The amounts can be based on conditions, such as weather conditions. Presenting the different amounts allows the user to select an amount that best fits their needs (high power for short period followed by low power or medium power continuously, etc.).

The control module 36 can, in some examples, use power from a 12-Volt system 80 of the vehicle 10 to supplement power provided by the vehicle 10 to the load 14. The 12-Volt system 80 can, in some examples, provide an extra 2 kilowatts of surge power to boost total output from the vehicle 10 to approximately 10 kilowatts. This is achieved by turning off or putting into a sleep state electrically powered elements of the vehicle 10 that are not directly needed to use the vehicle 10 to supply electrical energy to the load 14.

The control module 36 can, in some examples, cause a notification to be relayed to a user. The notification can provide an estimate of how long the vehicle 10 can power the load 14. The estimate can be based on an amount of fuel in the vehicle 10. The estimate can, for example, inform the user how many hours the vehicle 10 can continue to power the load 14 at the current level of demand.

The control module 36 can, in some examples, operate the engine 22 according to a particular output profile. An example profile for the engine 22 could include an aggressive initial RPM for short support of comfort/critical loads followed by nominal RPM for maintenance (e.g. dynamic overcompensation etc.). Another profile could include operating according to a balanced RPM for continuous reduced support (e.g. threshold, dynamic matching etc.). Yet another profile could include rationed RPM to support critical loads at specific intervals only (e.g. targeted, energy profile pairing, reserve strategy etc.).

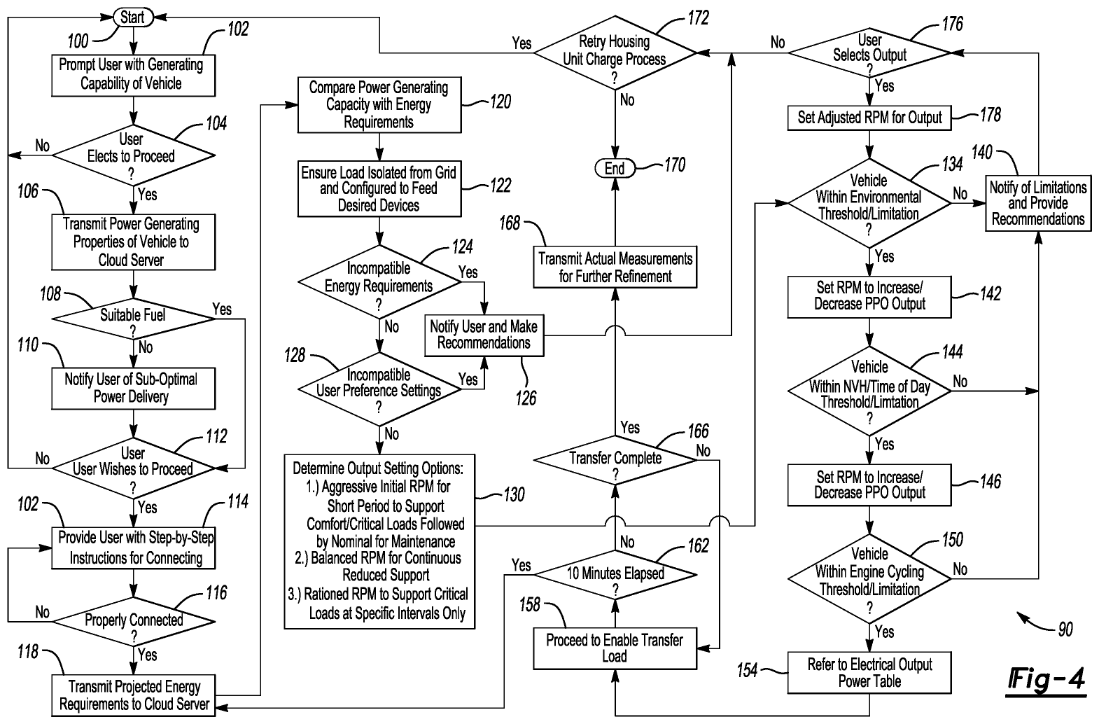

With reference to FIG. 4 and continuing reference to FIGS. 1-3, an example method 90 associated with powering the load 14 from the vehicle 10 begins at a step 100. Next, at a step 102, a user is prompted with an electrical power generating capability of the vehicle 10 (10 kilowatts, 7.2 kilowatts, etc.). The method 90 then moves to a step 104 where the user decides whether or not to proceed. If no, the method 90 returns to the start step 100. If yes, the method 90 moves to the step 106 where the power generating properties of the vehicle 10 are transmitted to the cloud sever.

Next, at a step 108, an amount of fuel in the vehicle 10 is assessed. If the fuel is inadequate to supply the engine 22 to generate the desired power, the method 90 provides the user with a notification at a step 110 that the delivery of power may be suboptimal, and then moves a step 112. If the fuel level is adequate, the method 90 moves from the step 108 directly to the step 112.

At the step 112, the user is requested to confirm that the method 90 should proceed. If yes, the method 90 moves to a step 114 where the user is provided with instructions explaining how to electrically couple the vehicle 10 to the load 14. After the user makes the connection, the method 90 confirms that the connection is properly made at a step 116.

Next, at a step 118, the projected energy requirements for the load 14 are transmitted to the server system 60. The projected energy requirements can be based on historical energy usage. Then, at a step 120, the power generating capacity of the vehicle 10 is compared to the energy requirements.

The method 90 then moves to a step 122, which verifies that the load 14 is isolated from the grid power source 18, and that a load panel, such as the panel 44, is configured to feed selected devices.

The method 90 then moves to a step 124 where the energy requirements for the load 14 and the energy generating capability of the vehicle 10 are assessed, along with other physical and performance requirements. If the requirements are incompatible, the method 90 moves to the step 126 where the user is notified of the detected incompatibility. The step 126 can include providing the user with recommendations for fixes (lowering the demand, increasing the generating capacity, etc.). If the requirements are compatible, the method 90 moves to the step 128.

At the step 128, the method 90 assesses whether or not the user preferences are compatible. If the user preferences are incompatible, the method 90 moves to the step 126. If the user preferences are compatible, the method 90 moves to the step 130, which determines output settings for energy from the vehicle 10.

From the step 130, the method 90 moves to the step 134 where the vehicle 10 is assessed to determine if the vehicle is within environmental thresholds/limitations. If no, the method 90 moves from the step 134 to the step 140 where the user is notified and provided with recommendations to adjust the RPM of the engine 22 to meet a desired generated output. If the vehicle 10 is within environmental thresholds/limitations at the step 134, the method 90 moves to the step 142 where the method 90 sets an RPM of the engine 22 to increase or decrease generated output.

From the step 142, the method 90 moves to the step 144 where the vehicle 10 is assessed to determine if the vehicle 10 is within a noise (e.g., NVH) threshold or limitation. If no, the method 90 moves to the step 140. If yes, the method 90 moves from the step 144 to the step 146 where the method 90 sets an RPM of the engine 22 to increase or decrease generated output.

The method 90 then moves to the step 150 where the vehicle 10 is assessed to determine if the vehicle is within an engine cycling threshold or limitation. If no, the method 90 moves to the step 140. If yes, the method 90 moves from the step 150 to a step 154, which refers to a steady state electrical output table. This could be a look up table or embedded values, for example.

From the step 154, the method moves to a step 158 where the method 90 enables a transfer of energy form the vehicle 10 to the load 14. The method 90 then moves to a step 162, which assesses whether a time period, here 10 minutes, has elapsed. If yes, the method 90 returns to the step 118. If no, the method 90 moves to a step 166.

The step 166 assesses whether or not the transfer of energy is complete. If not, the method 90 returns to the step 158. If yes, the method moves to a step 168. At the step 168, the actual measurements associated with the transfer are recorded and transferred to refine future predictions. The method 90 then ends at a step 170.

Returning again to the step 126, from the step 126, the method 90 can move to a step 172, which determines whether to charge process should be retried. If yes, the method 90 moves back to the start step 102. If no, the method 90 moves to the end step 170.

Returning to the step 140, from the step 140, the method 90 moves to a step 176 where the user selects a desired electrical output from the vehicle 10. If the user does not make a selection, the method 90 moves to the step 172. If the user does make a selection, the method 90 moves to a step 178 where the method 90 sets an adjusted RPM for the engine 22 to meet the output selected in the step 176. From the step 178, the method moves to the step 134.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A method, comprising:
operating a vehicle to generate electrical power;
outputting the electrical power from the vehicle to one or more loads external to the vehicle; and
adjusting the operating based, at least in part, on noise generated by the vehicle during the operating.

2. The method of claim 1, wherein the operating comprises operating an engine of the vehicle.

3. The method of claim 2, wherein adjusting the operating includes adjusting an idle speed of the engine.

4. The method of claim 1, further comprising monitoring the noise generated by the vehicle using at least one sensor of the vehicle.

5. The method of claim 4, wherein the at least one sensor is a microphone.

6. The method of claim 1, wherein the adjusting comprises adjusting based on a time of day.

7. The method of claim 1, wherein the adjusting is in response to noise generated by the vehicle exceeding a threshold noise level, wherein the threshold noise level changes based on a time of day.

8. The method of claim 7, wherein the threshold noise level is higher during the day than at night.

9. The method of claim 1, further comprising additionally adjusting the operating based, at least in part, on a weather condition.

10. The method of claim 9, wherein the weather condition is a temperature.

11. The method of claim 1, further comprising additionally adjusting the operating based, at least in part, on a temperature of an area of the vehicle.

12. The method of claim 1, wherein the operating is responsive to a request by a user of a vehicle to power the one or more loads external to the vehicle.

13. The method of claim 12, wherein the one or more loads includes a load from a residential home.

14. The method of claim 13, wherein the load from the residential home is adjusted based on the electrical power outputted from the vehicle.

15. The method of claim 1, further comprising additionally adjusting the operating based, at least in part, on a temperature within an engine compartment of the vehicle.

16. The method of claim 1, further comprising, during the outputting, including an outputting of power from a 12-Volt system of the vehicle.

17. The method of claim 1, further comprising, automatically starting the operating in response to a power outage.

18. A system for a vehicle, comprising:
an engine that can be driven to produce electrical power that is supplied to one or more loads that are external to the vehicle; and
a controller module that can adjusting an operating speed of the engine based, at least in part, on noise generated by the vehicle.

19. The system of claim 18, wherein the controller module is configured to automatically start the engine in response to a power outage.

20. The system of claim 18, wherein the adjusting is in response to noise generated by the vehicle exceeding a threshold noise level, wherein the threshold noise level changes based on a time of day.
